(19) United States
(12) Patent Application Publication
(10) Pub. No.: US 2021/0321739 A1
(43) Pub. Date: Oct. 21, 2021

(54) Mobile Holder for Hairdressing Tools and Accessories

(71) Applicant: Roman Viktorovich Kulikov, Moscow (RU)

(72) Inventor: Roman Viktorovich Kulikov, Moscow (RU)

(21) Appl. No.: 16/970,357

(22) PCT Filed: Oct. 15, 2019
(86) PCT No.: PCT/RU2019/000733

§ 371 Date: Jul. 6, 2021

(30) Foreign Application Priority Data
Apr. 12, 2019 (RU) 2019111075

(51) Int. Cl. A45D 20/14; F16B 1/00

(52) U.S. Cl. CPC A45D 20/14; F16B 2001/0035; F16B 1/00

(57) ABSTRACT

A provided utility model relates to holders for hairdressing tools and accessories, such as for a hair dryer. The technical result of the provided utility model is mobility in use with reliable fixation on a held surface. The technical result is achieved by the utility model including a holding element with an opening to dispose objects, a base element including a magnet, wherein the base element and the holding element are positioned in a single body in a horizontal plane at opposite ends of a holder, and wherein the magnet is positioned in the interior space of the base element.

A provided utility model relates to holders for hairdressing tools and accessories, such as for a hair dryer. The provided utility model can be installed both on a horizontal surface and thereunder, wherein the horizontal surface may be inclined or non-uniform (rough-finished).

At present, there is a large number of different holders that differ in the way they are attached to the surface.

From the prior art, a “Device for Holding an Electric Hair Dryer” (U.S. Pat. No. 5,842,670 of Dec. 1, 1998) is known, which consists of a base and a flexible tube on which a holder for the hair dryer is positioned. The holder comprises a cylindrical ring with a cut-out section. The device may be placed on a horizontal surface.

The disadvantages of the analogue can include the fact that the placement of the known holder is possible only on a flat horizontal surface; if the surface has even a slight slope, the holder will lose its stability. It is also worth noting that said analogue can hold relatively light hair dryers, since when placing heavier devices, a structure is needed, the base of which will have a big weight. Such holders are no longer mobile, and their use and movement become difficult.

A “Holder for Devices” (Patent US 2011057082 of Mar. 10, 2011) is known, which is used to hold a hair dryer and can be placed on any surface, e.g. on a wall using various fasteners: screws, bolts, adhesives, magnets, fastening elements with hooks and loops.

The disadvantages of the known analog are the design complexity and the need to use an additional fastening element, while additional mounting of the holder itself is required.

Also, a Holder for a Hair Dryer (Patent US 2013277517 of Oct. 24, 2013) is known, which includes a frame for placing a hair dryer nozzle consisting of an element for placing an upper nozzle and an element for placing a lower nozzle, each being formed of a steel wire bent into a horizontal, usually flat, hollow geometric shape such as a hollow square. The frame for placing the nozzle is supported by a substantially L-shaped arm attached at one end to a vertical support of the frame for placing the nozzle. The opposite end of the L-shaped arm member is attached to a spring clip, which in turn is attached to an edge of the work surface or the other edge to support the entire hair dryer holder assembly and the hair dryer. The L-shaped arm may be formed with an angle between the sides of less than 900 such that when the hair dryer is inserted into the frame for placing the nozzle, the hair dryer nozzle is directed toward the surface and away from the user.

The discussed analogue is mobile and may be placed on a horizontal surface, including a surface with a slight slope, however, the contained spring mechanism is difficult to use, since much effort is required to fix the hair dryer to the edge of the table. In addition, clamping spring mechanisms often fail when constantly used, so they are not reliable in everyday use.

The analogues are known that are placed on vertical surfaces (walls) (DE 20101021740 of May 30, 2010 and DE 10200705,635 of Nov. 8, 2007) and include a magnetic element and a supporting element with an opening, which is a holder for various objects.

A disadvantage of said analogues is the lack of placement of said devices on the horizontal surface.

A universal holder for hair dryers (U.S. Pat. No. 8,151,481 of Apr. 10, 2012) is known, which includes a base including a suction mechanism for detachable fastening of the base to a generally flat surface, and an adjustable arm protruding from the base. The holder also includes a stand for holding the hair dryer at the arm end opposite to the base.

Said analogue may be placed both on a vertical surface and on a horizontal surface but can be reliably fixed only on a smooth surface, since the suction mechanism can only be attached to the smooth and clean surface, otherwise reliable fixation cannot be provided by such a mechanism. Additionally, it should be noted that the device for fixing the hair dryer on the holder requires additional fixation, which is due to the design of said analogue.

Also, an analogue “Stand for a Hair Care Device” (Patent GB 2560889 of Mar. 22, 2017) is known from the prior art, which includes a first storage position for a device and at least one additional storage position for an attachment. The additional storage position is provided for connecting an attachment to a support. A holder includes a support part and a base part. The base part is designed to be positioned on a surface while the base part extends over the base part and includes the first storage position and the additional storage positions. The additional storage position can include a second and a third storage positions. The device and attachments can be attached to the support using magnetic means or mechanical attachments.

Said analogue is mobile, reliably fixes the device and attachments on the surface of the support part and may be placed on a horizontal surface.

A disadvantage of said analogue is the possibility of placement only on the surface, which is attributed to the analogue design. It is worth noting that the design of the holder described in the analogue is intended for a specific model of the hair dryer, including a number of features. Thus, said analogue cannot be used to hold the majority of hair dryers currently presented on the market.

The analogue closest to the claimed technical solution is the Multifunctional Magnetic Holder (Patent KR 20150050911 of Nov. 1, 2013). The holder is configured to be suspended on metal surfaces using magnetic force and includes: a base holding element, in which a pair of magnets is positioned and an annular element with an opening for placing and holding objects.

The analogue disadvantages can relate to the lack of placement on the horizontal surface, since the base element including the magnet is positioned in a plane orthogonal to the holding element of the holder.

Often, when using the hair dryer, a situation may arise when the work surface area is not enough to install the holder, for example, when replacing the tool. In this situation, the need arises to use the holder in a limited space on the work surface, in which case a device is required that can be fixed under the table surface (table top).

The provided mobile holder for hairdressing tools and accessories with magnetic properties is free from said disadvantages.

The technical result of the provided utility model is mobility in use with reliable fixation on a held surface.

The provided utility model may be securely fixed on a horizontal metal or other magnetized surface.

A utility model including a holding element with an opening for placing objects, a base element including a magnet, is characterized in that the base element and the holding element are positioned in a single body in a horizontal plane at opposite ends of the holder, wherein the magnet is positioned in the interior space of the base element.

In another preferred embodiment of the utility model, the interior space of the opening of the holding element includes a ring of non-slip material.

The element holding on the surface may include a weight.

The utility model is illustrated by the following drawing.

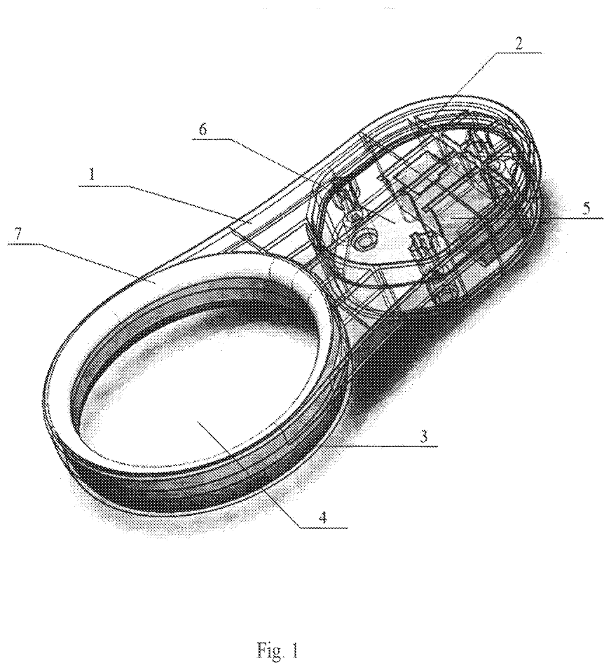

FIG. 1 is a general view of the utility model, where:
1—body;
2—element holding on the attachable surface;
3—annular element;
4—opening for objects;
5—magnet;
6—space for placing a magnet;
7—ring made of non-slip material;
8—weight.

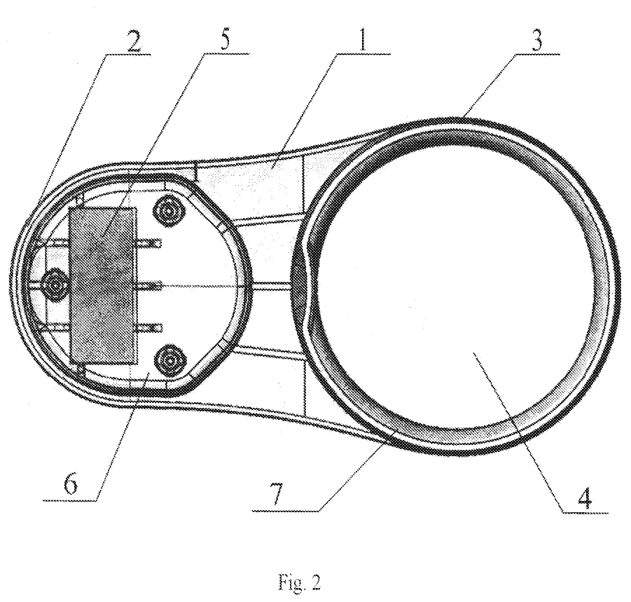

FIG. 2 is a general bottom view of the utility model.

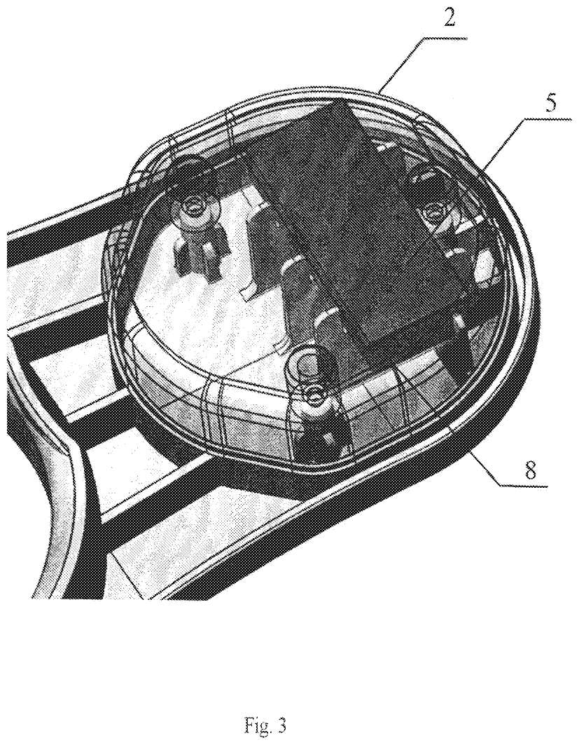

FIG. 3 shows a holding element.

The provided utility model is implemented as follows.

A mobile holder for hairdressing tools and accessories includes a body 1, which consists of an element 2 holding on the attachable surface and an annular element 3.

In a preferred embodiment of the utility model, as shown in the drawings, the holding element 2 is made as a protruding element, a heel with a space 6 for placing a magnet 5.

The protruding element 2 is made as a cover attachable to the holder body via various fastening elements.

The holder is made flat and horizontally oriented. On the side opposite to the holding element 2 along one longitudinal axis the annular element 3 with an opening 4 is positioned, which is designed to dispose and hold hairdressing tools or accessories. The opening 4 can include a ring made of non-slip material 7, for example elastomer, rubber, silicone, providing additional fixation to hairdressing tools or accessories.

The body may be made of any material allowing a magnetic field to pass through, for example, plastic.

Before use, the mobile holder is placed by the holding element 2 on a necessary surface, for example, a table having a layer of ferrimagnetic material. In this case, the annular element 3 is placed outside the table surface. With this positioning, the opening for objects 4 will be available for use.

The positioning of the holding element 2 with the magnet 5 and the annular element 3 in the longitudinal plane at opposite ends of the mobile holder provides for stable and reliable fixation on the surface. For the most reliable fixation, the magnet is placed at the edge of the holder as far as possible from the holding element, thereby increasing the resistance to the pressure force acting for pulling away the holder from the surface.

At the moment when the holding object, such as a hair dryer, is inserted in the annular element, a downward force acts on this part of the holder and tries to pull the holding element away from the surface. The presence of the magnet positioned along the longitudinal axis of the holder, on the same level with the annular element (with a minimum discrepancy in the levels of the longitudinal axes of the annular element and the central part of the holding element), compensates for said force and is distributed along the entire holder, which makes it possible to securely hold the holder in the working position and easily pull it away when lifting the mobile holder by the annular element upwards to move it to another place. Manufacturing the holder as a ring allows to make the holder light as much as possible, thereby reducing the forces acting for pulling away the holder from the surface.

Thus, the provided holder has mobility in use with reliable fixation on the held surface.

In a preferred embodiment of the holder, a weight 8 may be placed in the cavity of the holding element 2, which creates additional resistance to the force acting for pulling away the holder from the surface.

If necessary, in a limited space on the surface, the mobile holder may be placed under the surface to be used, wherein the reliable fixation will also be provided.

1. A holder for hairdressing tools and accessories, comprising:
an annular element for placing objects,
an element for holding on a surface, comprising a magnet,
wherein the annular element and the holding element are positioned in a single body along its horizontal plane at opposite ends of the holder.

2. The holder of claim 1, wherein an interior part of an opening for placing objects comprises a ring made of a non-slip material.

3. The holder of claim 1, wherein the element for holding on the surface comprises a weight.
